(19) United States
(12) Patent Application Publication
(10) Pub. No.: US 2014/0313180 A1
(43) Pub. Date: Oct. 23, 2014

(54) ORGANIC LIGHT EMITTING DISPLAY PIXEL AND DISPLAY DEVICE

(71) Applicant: Samsung Display Co., Ltd., Yongin-City (KR)

(72) Inventor: Min-Kyu WOO, Yongin-City (KR)

(73) Assignee: Samsung Display Co., Ltd., Yongin-City (KR)

(21) Appl. No.: 14/020,182

(22) Filed: Sep. 6, 2013

(30) Foreign Application Priority Data
Apr. 17, 2013 (KR) 10-2013-0042147

(51) Int. Cl. G09G 3/36; H05B 33/08

(52) U.S. Cl. CPC G09G 3/3696; H05B 33/0896
USPC 345/212; 315/173

(57) ABSTRACT

A pixel according to an embodiment of the present invention includes an organic light emitting diode (OLED), a first transistor for controlling an amount of current supplied from a first power supply coupled thereto to the OLED via a second node to correspond to a voltage applied to a first node, a first capacitor coupled between the first node and the second node, a second capacitor coupled between the first power supply and the first node, and a second transistor coupled between the second node and a data line and turned on when a scan signal is supplied to a scan line.

### CROSS-REFERENCE TO RELATED APPLICATION

Korean Patent Application No. 10-2013-0042147, filed on Apr. 17, 2013, and entitled: “Pixel and Organic Light Emitting Display Device Using the Same,” is incorporated by reference herein in its entirety.

### BACKGROUND

1. Field

Embodiments described herein relate to an organic light emitting display device.

2. Description of the Related Art

Flat panel displays overcome many disadvantages of conventional displays such as cathode ray tubes. One type of flat panel display generates images using organic light emitting diodes that generate light based on the re-combination of electrons and holes in an active layer. While these types of displays operate with high response speeds and lower power, improvements are still required.

### SUMMARY

Embodiments are directed to a pixel having a driving transistor that compensates for deviations in threshold voltage, and organic light emitting display device which includes such a pixel.

In accordance with one embodiment, a pixel includes an organic light emitting diode (OLED); a first transistor configured to control an amount of current supplied from a first power supply, coupled to the OLED through a second node, in response to a voltage applied to a first node coupled to a gate of the first transistor; a first capacitor coupled between the first node and the second node; a second capacitor coupled between the first power supply and the first node; and a second transistor coupled between the second node and a data line, wherein the second transistor turns on when a scan signal is supplied to a scan line. The first transistor may have a channel capacitance substantially equal to a capacitance of the second capacitor.

Also, the pixel may include a third transistor coupled between the first node and an initializing power supply, the third transistor turning on when the scan signal is supplied to the scan line; and a fourth transistor coupled between the second node and the first power supply, the fourth transistor having a turn on period which does not overlap a turn on period of the second transistor.

Also, the first transistor may have a first channel capacitance, and the first channel capacitance may be greater than channel capacitances of one or more of the second transistor, third transistor, or fourth transistor. A voltage of the initializing power supply may be lower than a voltage of the first power supply.

Also, the voltage of the first node and a voltage of the second node may increase at a time when the scan signal is supplied to the scan line and the second node is electrically insulated from the first power supply.

Also, the voltage of the first node may change from a first voltage to a second voltage in response to termination of the scan signal to the scan line, the first voltage corresponding to an initializing power supply. The voltage of the first node may change from the first voltage to the second voltage based on a voltage of a data signal applied to the data line. A difference between the first voltage and the second voltage may corresponds to a compensating threshold voltage of the first transistor.

Also, a voltage of the second node may change at a same time the voltage from the first node changes from the first voltage to the second voltage in response to terminal of the scan signal to the scan line.

Also, an amount of current supplied from the first power supply may be based on a difference between the second voltage of the first node and the changed voltage of the second node.

In accordance with another embodiment, an organic light emitting display device includes a scan driver configured to supply scan signals to scan lines and supply emission control signals to emission control lines; a data driver configured to supply data signals to data lines; and a plurality of pixels at respective intersections of the scan and data lines. Each pixel coupled to an i^{th} (i is a natural number) scan line may include an organic light emitting diode (OLED); a first transistor configured to control an amount of current supplied from a first power supply. coupled to the OLED through a second node, in response to a voltage applied to a first node coupled to a gate of the first transistor; a first capacitor coupled between the first node and the second node; a second capacitor coupled between the first power supply and the first node; and a second transistor coupled between the second node and a data line, wherein the second transistor turns on when a scan signal is supplied to the i^{th} scan line.

Also, the first transistor may have a channel capacitance substantially equal to a capacitance of the second capacitor. The first transistor may have a channel capacitor with a capacitance greater than a channel capacitance of the second transistor.

Also, each pixel may include a third transistor coupled between the first node and an initializing power supply, the third transistor turned on when the scan signal is supplied to the i^{th} scan line; and a fourth transistor coupled between the second node and the first power supply, the fourth transistor turned off when an emission control signal is supplied to an i^{th} emission control line and turned on when the emission control signal is not supplied to the i^{th} emission control line.

Also, the scan driver may supply the scan signal to the i^{th} scan line during a period that overlaps a period the emission control signal is supplied to the i^{th} emission control line. The initializing power supply may have a lower voltage than a voltage of the first power supply.

In accordance with another embodiment, a pixel includes a first transistor having a first terminal coupled to a first node, a second terminal coupled to a second node, and a third node coupled to an organic light emitting diode (OLED); a first capacitor coupled between the first node and the second node; and a second capacitor coupled between a first power supply and the first node. The first node may be coupled to a second power supply different from the first power supply, the first transistor may control an amount of current through the OLED, and the first transistor may have a channel capacitance substantially equal to a capacitance of the second capacitor.

Also, a second transistor may be coupled between a data line and the second node, wherein the second transistor is controlled by a scan signal and wherein the channel capacitance of the first transistor is greater than a channel capacitance of the second transistor.

### BRIEF DESCRIPTION OF THE DRAWINGS

Features will become apparent to those of ordinary skill in the art by describing in detail exemplary embodiments with reference to the attached drawings in which:

FIG. 1 illustrates an embodiment of an organic light emitting display (OLED) device;

FIG. 2 illustrates an embodiment of a pixel in the OLED device in FIG. 1;

FIG. 3 illustrates an embodiment of a method of driving the pixel in FIG. 2; and

FIG. 4 illustrates a C-V curve corresponding to a deviation in threshold voltages of a driving transistor.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

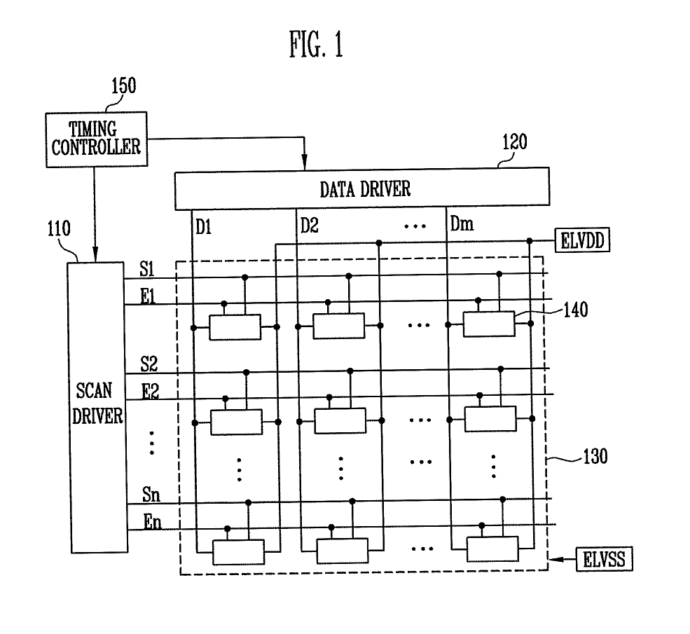

FIG. 1 shows an embodiment of an organic light emitting display device which includes a pixel unit 130 including pixels 140 positioned to be coupled to scan lines S1 to Sn and data lines D1 to Dm, a scan driver 110 for driving the scan lines S1 to Sn and emission control lines E1 to En, a data driver 120 for driving the data lines D1 to Dm, and a timing controller 150 for controlling the scan driver 110 and the data driver 120.

The scan driver 110 supplies scan signals to the scan lines S1 to Sn and supplies emission control signals to the emission control lines E1 to En to correspond to control of the timing controller 150. For example, the scan driver 110 sequentially supplies the scan signals to the scan lines S1 to Sn and sequentially supplies the emission control signals to the emission control lines E1 to En. Here, a scan signal supplied to an ith (i is a natural number) scan line overlaps an emission control signal supplied to an ith emission control line. On the other hand, the scan signals are set to have voltages (for example, low voltages) at which transistors included in the pixels 140 may be turned on and the emission control signals are set to have voltages (for example, high voltages) at which transistors included in the pixels 140 may be turned off.

The data driver 120 supplies the data signals to the data lines D1 to Dm to correspond to the control of the timing controller 150. For example, the data driver 120 supplies the data signals to the data lines D1 to Dm in synchronization with the scan signals.

The timing controller 150 controls the scan driver 110 and the data driver 120 to correspond to synchronizing signals supplied from an external source.

The pixel unit 130 includes the pixels 140 positioned at intersections of the scan lines S1 to Sn and the data lines D1 to Dm. The pixels 140 are selected in units of horizontal lines to correspond to the scan signals supplied to the scan lines S1 to Sn to receive the data signals. The pixels 140 control an amount of currents that flow from a first power supply ELVDD to a second power supply ELVSS via organic light emitting diodes (OLED) to correspond to the supplied data signals to generate light components with predetermined brightness components.

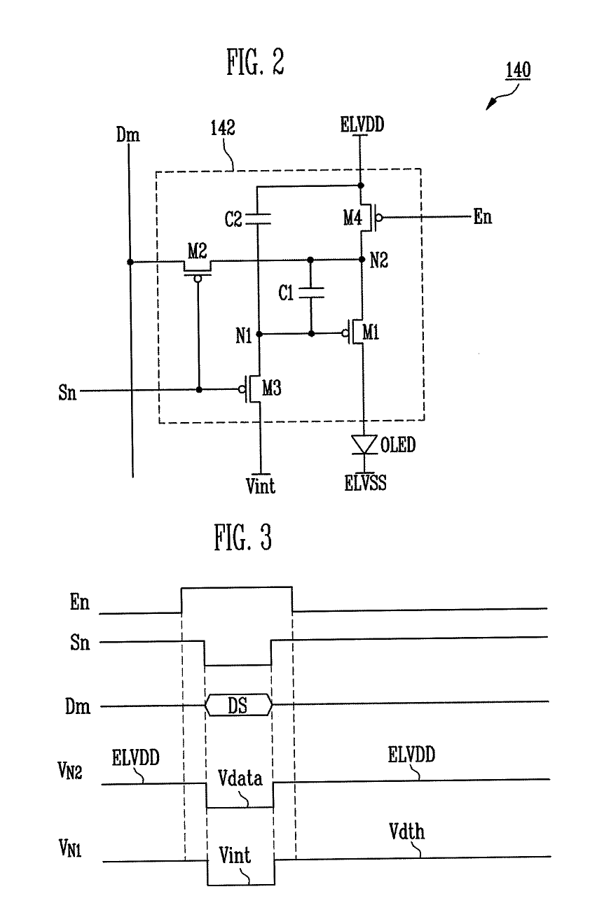

FIG. 2 shows an embodiment of a pixel that may be included in the display device of FIG. 1. In this figure, for convenience sake, the pixel is shown coupled to the n^{th} scan line Sn and the m^{th} data line Dm.

Referring to FIG. 2, a pixel 140 includes an organic light emitting diode (OLED) and a pixel circuit 142 coupled to the scan line Sn, the data line Dm, and the emission control line En to control an amount of current supplied to the OLED. An anode electrode of the OLED is coupled to the pixel circuit 142 and a cathode electrode of the OLED is coupled to the second power supply ELVSS. The OLED generates light with predetermined brightness to correspond to the amount of current supplied from the pixel circuit 142.

The pixel circuit 142 controls the amount of current supplied to the OLED to correspond to a data signal. In this embodiment, the pixel circuit 142 includes first to fourth transistors M1 to M4 and first and second capacitors C1 and C2.

A first electrode of the first transistor M1 is coupled to a second node N2 and a second electrode of the first transistor M1 is coupled to the anode electrode of the OLED. A gate electrode of the first transistor M1 is coupled to a first node N1. The first transistor M1 controls the amount of current supplied to the OLED to correspond to a voltage applied to the first node N1, that is, a voltage charged in a second capacitor C2.

A first electrode of the second transistor M2 is coupled to the data line Dm and a second electrode of the second transistor M2 is coupled to the second node N2. A gate electrode of the second transistor M2 is coupled to the scan line Sn. The second transistor M2 is turned on when a scan signal is supplied to the scan line Sn to electrically couple the data line Dm and the second node N2 to each other.

A first electrode of the third transistor M3 is coupled to the first node N1 and the second electrode of the third transistor M3 is coupled to an initializing power supply Vint. A gate electrode of the third transistor M3 is coupled to the scan line Sn. The third transistor M3 is turned on when the scan signal is supplied to the scan line Sn to supply a voltage of the initializing power supply Vint to the first node N1. Here, the initializing power supply Vint is set to have a lower voltage than that of the first power supply ELVDD.

A first electrode of the fourth transistor M4 is coupled to the first power supply ELVDD and a second electrode of the fourth transistor M4 is coupled to the second node N2. A gate electrode of the fourth transistor M4 is coupled to the emission control line En. The fourth transistor M4 is turned off when an emission control signal is supplied to the emission control line En and is turned on when the emission control signal is not supplied.

The first capacitor C1 is coupled between the second node N2 and the first node N1. The first capacitor C1 controls a voltage of the first node N1 to correspond to an amount of change in a voltage of the second node N2.

The second capacitor C2 is coupled between the first node N1 and the first power supply ELVDD. The second capacitor C2 charges a predetermined voltage to correspond to the data signal and to compensate for a threshold voltage of the first transistor M1.

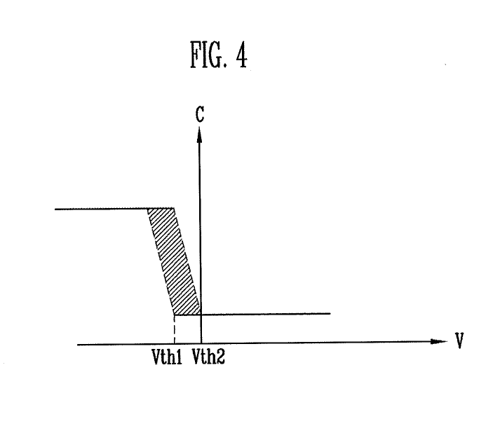

FIG. 3 is a waveform diagram corresponding to an embodiment of a method of driving the pixel in FIG. 2. Referring to FIG. 3, first, an emission control signal is supplied to the emission control line En so that the fourth transistor M4 is turned off. When the fourth transistor M4 is turned off, the first power supply ELVDD and the second node N2 are electrically insulated from each other so that the pixel 140 is set in a non-emission state.

Then, a scan signal is supplied to the scan line Sn and a data signal DS is supplied to the data line Dm. When the scan signal is supplied to the scan line Sn, the second transistor M2 and the third transistor M3 are turned on.

When the second transistor M2 is turned on, the data signal DS from the data line Dm is supplied to the second node N2. Then, a data voltage Vdata is applied to the second node N2 to correspond to the data signal DS. When the third transistor M3 is turned on, a voltage of the initializing power supply Vint is supplied to the first node N1.

After the data voltage Vdata is supplied to the second node N2, supplies of the scan signal and the emission control signal are sequentially stopped. When the supply of the scan signal to the scan line Sn is stopped, the second transistor M2 and the third transistor M3 are turned off. When the supply of the emission control signal to the emission control line En is stopped, the fourth transistor M4 is turned on.

When the fourth transistor M4 is turned on, a voltage of the second node N2 is increased from a voltage of the data signal to a voltage of the first power supply ELVDD. At this time, a voltage of the first node N1 is also increased by the first capacitor C1 and a channel capacitor of the first transistor M1. Since the voltage of the first power supply ELVDD is fixed, an amount of increase in the voltage of the second node N2 is determined by the voltage Vdata of the data signal DS. Therefore, the voltage of the first node N1 is controlled by the data signal DS.

Then, the first transistor M1 controls an amount of current that flows from the first power supply ELVDD to the second power supply ELVSS via an OLED to correspond to the voltage applied to the first node N1, that is, the data signal DS. Then, the OLED generates light with a brightness that corresponds to the amount of current supplied thereto.

In accordance with at least one embodiment, the voltage applied to the first node N1 may correspond to a voltage Vdth obtained by compensating for a deviation in threshold voltages due to a difference in amounts of charges corresponding to the threshold voltages. More specifically, when the pixel 140 emits light, the amount of current that flows to the OLED is determined by Equation 1:

I=K(Vg−Vs−Vth)²=K(Vg−ELVDD−Vth)² (1)

In Equation 1, Vg, Vs, Vth, and K correspond to the voltage of the first node N1, the voltage of the second node N2, the threshold voltage of the first transistor M1, and a constant, respectively. Based on Equation 1, currents that flow through two pixels in which their respective driving transistors (that is, M1) is set to have different threshold voltages may be determined by Equation 2. The different threshold voltages may arise, for example, due to age, process deviations, or other effects. For convenience sake, it is assumed, in Equation 2, that the same data signal is supplied to the first pixel and the second pixel.

I1=K(Vg1−Vs−Vth1)²

I2=K(Vg2−Vs−Vth2)²=K(Vg2−Vs−(Vth1+Δ))² (2)

In Equation 2, Vth1, Vth2, Vg1, and Vg2 refer to a threshold voltage of a driving transistor included in the first pixel, a threshold voltage of a driving transistor included in a second pixel, a voltage of a first node N1 of the first pixel, and a voltage of a first node n1 of the second pixel, respectively. Also, in Equation 2, the symbol Δ means Vth2-Vth1.

More specifically, in Equation 2, Vg2-Vg1=Δ in order to satisfy the case where I1=I2. When the pixel emits light, the voltage of the first node N1 of the first pixel is determined by Equation 3 to correspond to an amount of change in the voltage of the second node N2. The voltage of the first node N1 of the second pixel is determined by Equation 4 to correspond to an amount of change in the voltage of the second node N2.

Vg1=Vint+ΔV1 (3)

Vg2=Vint+ΔV2 (4)

In Equations 3 and 4, when ΔV2−ΔV1=Δ is satisfied, I1=I2. Here, since Q=CV, ΔV2-ΔV1 may be determined by Equation 5:

$$Δ V 2 - Δ V 1 = \frac{Δ Q 2}{C 2} - \frac{Δ Q 1}{C 2} = \frac{Δ Q}{C 2} \qquad ( 5 )$$

In Equation 5, when a C-V curve of the driving transistor is determined based on Equation 4, an area of a hatched part is ΔQ. When it is assumed that the hatched area of FIG. 4 is a parallelogram, ΔQ is determined by Equation 6:

ΔQ=C_{channel}(Vth2−Vth1) (6)

In Equation 6, C_{channel} corresponds to the channel capacitor of the driving transistor M1. When ΔQ is determined by Equation 6, ΔV2−ΔV1 may be as set forth in Equation 7:

$$Δ V 2 - Δ V 1 = \frac{Δ Q}{C 2} = \frac{{C}_{channel } ( Vth 2 - Vth 1 )}{C 2} = \frac{{C}_{channel} \times Δ}{C 2} \qquad ( 7 )$$

In Equation 7, when C_{channel}=C2, ΔV2−ΔV1=Δ is satisfied. Therefore, an image with uniform brightness may be realized by the first pixel and the second pixel regardless of the deviation in the threshold voltages of the driving transistor.

In accordance with one embodiment, the channel capacitor C_{channel} of the driving transistor M1 has the same capacity as that of the second capacitor. According to one embodiment, the channel capacitor C_{channel} of the first transistor M1 may be provided so that the channel capacitor of the driving transistor M1 has a capacitance which is the same as or similar to that of the second capacitor C2 and larger than channel capacitances of other transistors, e.g., one or both of transistors M2 and M3.

In one embodiment, the transistors in the pixel circuit may be PMOS transistors. However, in other embodiments, the transistors may be NMOS transistors or a combination of NMOS and PMOS transistors may be used.

Also, in at least one embodiment, the OLEDs in the pixels may generate red, green, or blue light corresponding to the amount of current supplied from respective driving transistors. In other embodiments, the OLEDs in the pixels may all generate white light to correspond to the amount of current supplied from respective driving transistors. In this case, a color image may be realized using various color filters.

By way of summation and review, an organic light emitting display device includes a plurality of pixels arranged at intersections of a plurality of data lines and scan lines in a matrix. Each of the pixels commonly includes an OLED, at least two transistors including a driving transistor, and at least one capacitor. The organic light emitting display device uses a small amount of power.

In conventional devices, the amount of current that flows to OLEDs varies with deviations in threshold voltages of the driving transistors. Also, characteristics of the driving transistors vary with manufacturing process variables. Also, conventionally, it is not possible to make all the transistors of an organic light emitting display device have the same characteristic in current processes. Therefore, deviations in threshold voltage of the driving transistors are generated, which produces non-uniformities that degrade picture quality.

Various approaches have been proposed in attempt to solve this problem. One approach involves adding a compensating circuit formed of a plurality of transistors and capacitors to each of the pixels. The compensating circuits diode-couple the driving transistors in a period where the scan signals are supplied, to compensate for the deviation in the threshold voltages of the driving transistors. However, this approach makes it difficult to provide a high-resolution display.

A pixel formed according to one or more of the aforementioned embodiments may provide an improved solution which addresses these drawbacks. In accordance with at least one embodiment, deviations in the threshold voltage of the driving transistors may be compensated by designing the pixel circuit of the pixel to include the four transistors and two capacitors as described herein. In addition, because the driving transistor is not diode-coupled, it is possible to reduce the number of signal lines and, thus, to form a high-resolution panel.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A pixel, comprising:
an organic light emitting diode (OLED);
a first transistor configured to control an amount of current supplied from a first power supply coupled through a second node to the OLED in response to a voltage applied to a first node coupled to a gate of the first transistor;
a first capacitor coupled between the first node and the second node;
a second capacitor coupled between the first power supply and the first node; and
a second transistor coupled between the second node and a data line, wherein the second transistor turns on when a scan signal is supplied to a scan line.

2. The pixel as claimed in claim 1, further comprising:
a third transistor coupled between the first node and an initializing power supply, the third transistor turning on when the scan signal is supplied to the scan line; and
a fourth transistor coupled between the second node and the first power supply, the fourth transistor having a turn on period which does not overlap a turn on period of the second transistor.

3. The pixel as claimed in claim 2, wherein:
the first transistor has a first channel capacitance, and
the first channel capacitance is greater than channel capacitances of one or more of the second transistor, third transistor, or fourth transistor.

4. The pixel as claimed in claim 2, wherein a voltage of the initializing power supply is lower than a voltage of the first power supply.

5. An organic light emitting display device, comprising:
a scan driver configured to supply scan signals to scan lines and supply emission control signals to emission control lines;
a data driver configured to supply data signals to data lines; and
a plurality of pixels at respective intersections of the scan and data lines, wherein each pixel coupled to an i^{th} (i is a natural number) scan line comprises:
an organic light emitting diode (OLED);
a first transistor configured to control an amount of current supplied from a first power supply. coupled to the OLED through a second node, in response to a voltage applied to a first node coupled to a gate of the first transistor;
a first capacitor coupled between the first node and the second node;
a second capacitor coupled between the first power supply and the first node; and
a second transistor coupled between the second node and a data line, wherein the second transistor turns on when a scan signal is supplied to the scan line.

6. The organic light emitting display device as claimed in claim 5, wherein the first transistor has a channel capacitor with a capacitance greater than a channel capacitance of the second transistor.

7. The organic light emitting display device as claimed in claim 5, wherein each pixel further comprises:
a third transistor coupled between the first node and an initializing power supply, the third transistor turned on when the scan signal is supplied to the i^{th} scan line; and
a fourth transistor coupled between the second node and the first power supply, the fourth transistor turned off when an emission control signal is supplied to an i^{th} emission control line and turned on when the emission control signal is not supplied to the i^{th} emission control line.

8. The organic light emitting display device as claimed in claim 5, wherein the scan driver supplies the scan signal to the i^{th} scan line during a period that overlaps a period the emission control signal is supplied to the i^{th} emission control line.

9. The organic light emitting display device as claimed in claim 5, wherein the initializing power supply has a lower voltage than a voltage of the first power supply.
